(19) United States
(12) Patent Application Publication
(10) Pub. No.: US 2008/0018385 A1
(43) Pub. Date: Jan. 24, 2008

(54) Electric power circuit for driving display panel

(75) Inventor: Yoshimichi Ureshino, Miyazaki (JP)

Correspondence Address: NIXON PEABODY, LLP, 401 9TH STREET, NW, SUITE 900, WASHINGTON, DC, 20004-2128, US

(73) Assignee: OKI ELECTRIC INDUSTRY CO.,LTD.

(21) Appl. No.: 11/812,415

(22) Filed: Jun. 19, 2007

(30) Foreign Application Priority Data
Jul. 20, 2006 (JP) 2006-197719

(51) Int. Cl. G05F 1/10; G06G 7/12

(52) U.S. Cl. 327/540; 327/563

(57) ABSTRACT

An electric power circuit for driving a display panel, which supplies a plurality of gradation voltages to driver parts of the display panel, is provided. The electric power circuit has a fine-controlling circuit for fine-controlling the gradation voltage in response to a difference between the gradation voltage and a referential voltage, by which excess increase and decrease of the gradation voltage can be appropriately suppressed. Therefore, the electric power circuit can generates a stable gradation voltage.

### BACKGROUND OF THE INVENTION

1. Field of the Invention

The present invention relates to an electric power circuit, and in particular, relates to an electric power circuit for driving a display panel, which circuit supplies a plurality of gradation voltages to driver parts of the liquid crystal panel.

2. Description of the Related Art

A conventional driver integrated circuit (IC) for driving a STN (Super Twisted Nematic) liquid crystal panel is configured by a plurality of segment (SEG) driver parts and a plurality of common (COM) driver parts. Each of the SEG driver parts has a SEG terminal via which a signal voltage is applied to a liquid crystal element. Each of the COM driver parts has a COM terminal via which a scanning voltage is applied to a liquid crystal element. The driver IC is connected to an electric power circuit for supplying gradation voltages to the plurality of the COM and SEG driver parts. A conventional electric power circuit is described in, for example, Japanese Patent Application Laid-Open Publication No. H08-313867 (document D1).

The conventional electric power circuit of document D1 is described with reference to FIG. 1 of the accompanying drawings. FIG. 1 is a schematic circuit diagram showing the conventional electric power circuit 30 supplying gradation voltages to, for example, one hundred SEG driver parts 10 and, for example, one hundred COM driver parts 20. The electric power circuit 30 generates gradation voltages of VSS, V1, V2, V3, V4, and V5, each of which are different from each other. The gradation voltages of VSS, V2, V3, and V5 are supplied to the SEG parts 10. The gradation voltages of VSS, V1, V4, and V5 are supplied to the COM parts 20.

As shown in FIG. 1, each of the SEG driver parts 10 has four switches and a SEG terminal 11 connected to the four switches. The four switches, which are connected in parallel to each other, selectively supply gradation voltages generated by the electric power circuit 30 to a liquid crystal element. The four switches are respectively configured by a p-channel type MOS transistor (hereafter “PMOS”) 12-1, an analogue switch 12-2 having a PMOS 12-2a and an n-channel type MOS transistor (hereafter “NMOS”) 12-2b, an analogue switch 12-3 having a PMOS 12-3a and an NMOS 12-3b, and an NMOS 12-4.

The PMOS 12-1 operates as a switch for supplying a gradation voltage having the V5 level(=8 volts) to the SEG terminal 11. The analogue switch 12-2 operates as a switch for supplying a gradation voltage of V3(=4 volts) to the SEG terminal 11. The analogue switch 12-3 operates as a switch for supplying a gradation voltage of V2(=2 volts) to the SEG terminal 11. The NMOS 12-4 operates as a switch for supplying a gradation voltage of VSS(=0 volts) to the SEG terminal 11. On/off switching operations of the PMOS 12-1, the analogue switches 12-2 and 12-3, and the NMOS 12-4 are controlled in response to a display control signal generated by a controlling circuit (not shown). The SEG terminals 11 are respectively connected to load carrying capacities 13 of the STN liquid crystal display panel.

Each of the COM driver part 20 has four switches and a COM terminal 21 connected to four switches. The four switches, which are connected in parallel to each other, selectively supply the gradation voltages generated by the electric power circuit 30 to a liquid crystal element. The four switches are respectively configured by a PMOS 22-1, an analogue switch 22-2 having a PMOS 22-2a and an NMOS 22-2b, an analogue switch 22-3 having a PMOS 22-3a and an NMOS 22-3b, and an NMOS 22-2b.

The PMOS 22-1 operates as a switch for supplying a gradation voltage of V5(=8 volts) to the COM terminal 21. The analogue switch 22-2 operates as a switch for supplying a gradation voltage of V4(=6 volts) to the COM terminal 21. The analogue switch 22-3 operates as a switch for supplying a gradation voltage of V1(=1 volts) to the COM terminal 21. The NMOS 22-4 operates as a switch for supplying a gradation voltage of VSS(=0 volts) to the COM terminal 21. On/off switching operations of the PMOS 22-1, the analogue switches 22-2, 22-3, and the NMOS 22-4 are controlled in response to the display control signal generated by the controlling circuit (not shown). The COM terminals 21 are respectively connected to load carrying capacities 23 of the STN liquid crystal display panel.

The electric power circuit 30 supplies the gradation voltages of V5, V3, V2 and VSS to the SEG driver parts 10 and supplies the gradation voltages of V5, V4, V1, and VSS to the COM parts 20. The electric power circuit 30 includes six resistors 31-1 to 33-6 connected in series across an electric power terminal (hereafter “VDD” terminal) and an earth terminal (hereafter “VSS” terminal), to which an electric power-supply voltage of VDD level and an earth voltage of VSS(=0 volts) level are respectively applied. The resistors 31-1 to 33-6 are utilized for respectively generate intermediate voltages across the VDD and VSS terminal necessary to drive the STN liquid crystal panel. The electric power circuit 30 also has five operational amplifiers (hereafter “op-amps”) 32-1 to 32-5. Each of the op-amps 32-1 to 32-5 operates as a voltage follower in response to the intermediate voltage between two adjoined resistors among the six resistors so as to decrease an output impedance.

The op-amps 32-1, 32-2, and 32-4, which generate the gradation voltages of V5, V4, and V2 respectively, are configured as PMOS buffer op-amps designed to correspond with a large load. The op-amps 32-3 and 32-5, which generates the gradation voltages of V3 and V1 respectively, are configured as NMOS buffer op-amps designed to correspond with a small load and decrease electric current consumption. Each of the NMOS buffer op-amps 32-3 and 32-5 is configured by a constant electric current source which provides a substantially constant electric current (for instance, 1 μA).

FIGS. 2A and 2B are schematic circuit diagrams showing the PMOS buffer op-amp and the NMOS buffer op-amp of FIG. 1, respectively.

A PMOS buffer op-amp 40 shown in FIG. 2A includes a differential amplification stage 41 and an output stage 42. The differential amplification stage 41 has positive and negative input terminals IN(+) and IN(−). The positive input terminal IN(+) is connected to the intermediate voltage between two adjacent resistors among the six resistors of FIG. 1. The negative input terminal IN(−) is connected to a gradation voltage on an output terminal OUT. The differential amplification stage 41 inputs input voltages supplied from the positive and negative input terminals IN(+) and IN(−) and generates a differential output voltage corresponding to a difference between the input voltages. In response to the differential output voltage of the differential amplification stage 41, the output stage 42 generates a gradation voltage to the output terminal OUT.

The differential amplification stage 41 is configured by a current mirror pair of PMOS's 41a, 41b, a differential input pair of NMOS's 41c, 41d, and an NMOS 41e. The current mirror pair of the PMOS's 41a, 41b configures a current mirror circuit. The differential input pair of the NMOS's 41c, 41d is gate-controlled by the input voltages respectively supplied from the negative input terminal IN(−) and the positive input terminal IN(+) to gate terminals thereof. The NMOS 41e operating as a constant current source flowing a substantially constant electric current from the differential input pair NMOS's 41c, 41d to the earth terminal VSS in response to a bias voltage VBP. The output stage 42 is configured by a PMOS 42a and an NMOS 42b. The PMOS 42a operates as a PMOS buffer so as to generate a gradation voltage. The NMOS 42b operates as a constant current source flowing a substantially constant electric current (for instance, 1 μA) to the VSS terminal in response to the bias voltage VBP. A capacitor 43 with a predetermined capacity (for instance, about 0.1 μF), which is provided so as to stabilize the gradation voltage, is connected between drain and gate terminals of the PMOS 42a.

An NMOS buffer op-amp of FIG. 2B includes a differential amplification stage 51 and an output stage 52. The differential amplification stage 51 has positive and negative input terminals. The positive input terminal IN(+) is connected to an intermediate voltage across two adjacent resistors among the six resistors of FIG. 1. The negative input terminal IN(−) is connected to a gradation voltage on an output terminal OUT. The differential amplification stage 51 inputs input voltages supplied from the positive and negative input terminals and generates a differential output voltage corresponding to a difference between the input voltages supplied from negative and positive input terminals IN(−) and IN(+). In response to the differential output voltage from the differential amplification stage 51, the output stage 52 generates a gradation voltage to the output terminal OUT.

The differential amplification stage 51 is configured by a PMOS 51a, a differential input pair of PMOS's 51b, 51c, a current mirror pair of NMOS's 51d, 51e. The PMOS 51a operates as a constant current source flowing a substantially constant electric current to the differential input pair PMOS's 51b and 51c in response to the bias voltage VBN. The differential input pair PMOS's 51b, 51c are gate-controlled by the input voltages supplied from negative and positive input terminals IN(−) and IN(+) to gate terminals thereof. The output stage 42 is configured by a PMOS 52a and an NMOS 52b. The NMOS 52b operates as an NMOS buffer so as to generate a gradation voltage. The PMOS 52a operates as a constant current source flowing a constant electric current (for instance, 1 μA) in response to the bias voltage VBN. A capacitor 53 with a predetermined capacity (for instance, about 0.1 μF), which is provided so as to stabilize the gradation voltage, is connected between drain and gate terminals of the NMOS 52a.

In the circuit configurations of FIGS. 2A and 2B, the gradation voltages of VSS, V2, V3, and V5 are supplied from the electric power circuit 30 to the SEG driver parts 10, and the gradation voltages of VSS, V1, V4, and V5 are supplied to the COM driver parts 20. On/off switching operations of the PMOS 12-1, the analogue switches 12-2, 12-3, and the NMOS 12-4 of the SEG driver part 10 are controlled in response to a display controlling signal generated from the controlling circuit (not shown). On/off switching operations of the PMOS 22-1, analogue switches 22-2, 22-3, and the NMOS 22-4 of the COM driver part 20 are also controlled in response to the display controlling signal. The gradation voltages of V5, V3, V2, and VSS, whose timings are determined from a predetermined timing, are selectively supplied to the STN liquid display panel via the SEG terminals 11. The gradation voltages of V5, V4, V1, and VSS, whose timings are determined from a predetermined timing, are supplied he STN liquid display panel via the COM terminals 21. In this way, the STN liquid crystal display panel is driven.

FIG. 3 is an operation waveform chart showing changes of a gradation voltage provided from one of the SEG terminal 11 of FIG. 1. As shown in FIG. 3, the gradation voltage having different levels V5, V3, V2, and VSS is generated.

In the electric power circuit 30, the PMOS 12-1 is selectively turned on so as to increase in a level of the gradation voltage from V3 to V5. The analogue switch 12-3 is turned on so as to increase in a level of the gradation voltage from VSS to V2. The analogue switch 12-2 is selectively turned on so as to decrease in a level of the gradation voltage from V5 to V3. The NMOS 12-4 is selectively turned on so as to decrease in a level of the gradation voltage from V2 to VSS. In the same way as the SEG driver part, the PMOS and NMOS buffer op-amps of the COM driver part are selectively turned on/off so as to increase and decrease in levels of gradation voltages.

The conventional electric power circuit 30 show in FIG. 1, however, has the following problems, which is described in reference to FIGS. 4 and 5. FIG. 4 is a schematic circuit diagram showing a path of a leak electric current flowing through the PMOS buffer op-amp 32-4 of FIG. 2A. FIG. 5 is a timing chart showing an increase of a gradation voltage supplied from the SEG terminal 11 in the case that the leak electric current shown in FIG. 4 is generated.

At the time when, for example, an electric leakage current i1 of 1 nA (nano ampere) denoted by a dotted line of FIG. 4 is generated at high temperature through each of one hundred PMOS's 12-1, it is estimated that a total leakage current i2 generated through one hundred PMOS's 12-1 is 0.1 μA. If the total leakage current i2 flows back to, for example, the PMOS buffer op-amp 32-4 as shown in FIG. 4, a gradation voltage generated by the PMOS buffer op-amp 32-4 varies because the total leakage current i2 is shorted by the constant electric current of 1 μA through the NMOS 42b of the PMOS buffer op-amp 32-4.

The NMOS 42b operates as a constant electric current source which is configured so that a substantially constant electric current of 1 μA will flow to the VSS terminal. The NMOS 42b can not let an electric current more than 1 μA flow even under the generation of the leakage current i2 of 0.1 μA, thus the generation of the leakage current i2 is charged into the load carrying capacities 13. If the load carrying capacities 13 electrically reach a maximum, the gradation voltage increases from an appropriate level V2 as shown in FIG. 5. The gradation voltage of V5 and V2 are, for example, 8V and 2V, respectively. A gradation voltage Vout of 2.55V having fluctuations of +550 mV are applied to the SEG terminal 11.

Since an allowable variation width for appropriately driving a typical liquid crystal panel is about ±tens mV, the variation of the gradation voltage generated by the conventional electric power circuit is too high to appropriately drive the typical liquid crystal panel, thus causing defective errors in the liquid crystal panel. In order to generate a gradation voltage whose variation in voltage is within ±30 mV, it is necessary that a leakage electric current, from the PMOS 12-1 to the SEG terminal 11 is 50 pA at a maximum.

In the same way as the leakage electric current i1, another leakage electric current is generated from the PMOS 12-2 to the op-amp 32-4 generating the gradation voltage V2, which is not described for simplicity.

Assuming a variation in the level of a gradation voltage due to, for example, leakage electric currents occurring at relatively high temperature, the PMOS buffer op-amp 32-4 may be replaced by a push-pull op-amp having an NMOS and a PMOS so as to provide a gradation voltage as a push-pull output voltage. Electric current consumption in the push-pull op-amp, however, is large even at a steady state, and thus an electric power circuit having the push-pull op-amp is not usable for a mobile device.

### SUMMARY OF THE INVENTION

It is an object of the present invention to provide a electric power circuit for driving a display panel, which can suppress a variation in voltage level of a gradation voltage, so as to generate an appropriate gradation voltage to a driver part of a display panel even if the gradation voltage is influenced by an external load.

According to an aspect of the present invention, there is a provided an electric power circuit for driving a display panel comprising a reference voltage generation circuit for generating a plurality of reference voltages on the corresponding reference voltage terminals, and a plurality of amplifiers for respectively amplifying the plurality of reference voltages so as to generate gradation voltages to gradation output terminals. At least one of the amplifiers comprises a differential amplification circuit having a positive input terminal connected to the reference voltage terminal, a buffer amp driven by an output of said differential amplification circuit, for generating the gradation voltage, a feedback path by which the gradation voltage is feedbacked to a negative input terminal of the differential amplification circuit, a fine-controlling circuit for fine-controlling the gradation voltage in response to a difference between said gradation voltage and said referential voltage.

The fine-controlling circuit fine-controls the gradation voltage in response to a difference between said gradation voltage and said referential voltage, thus suppressing excess increase and decrease of the gradation voltage so that a well-stable gradation voltage is generated.

### BRIEF DESCRIPTION OF THE DRAWINGS

FIG. 1 is a schematic circuit diagram showing a conventional electric power circuit for driving a display panel;

FIG. 2A is a schematic circuit diagram showing a PMOS buffer operational amplifier of the conventional electric power circuit of FIG. 1;

FIG. 2B is a schematic circuit diagram showing a NMOS buffer operational amplifier of the conventional electric power circuit of FIG. 1;

FIG. 3 is a timing diagram of a change of a gradation voltage showing an operation of the conventional electric power circuit of FIG. 1;

FIG. 4 is a schematic circuit diagram showing a leakage electric current generated in the conventional electric power circuit of FIG. 1

FIG. 5 is a timing diagram of a change of a gradation voltage showing an operation of the conventional electric power circuit of FIG. 1 under leakage electric current of FIG. 4;

FIG. 6 is a schematic circuit diagram showing a first embodiment of the electric power circuit for driving a display panel according to the present invention;

FIG. 7 is a schematic circuit diagram showing an operational amplifier of the first embodiment of FIG. 6;

FIG. 8 is a timing diagram showing a gradation voltage of the first embodiment;

FIG. 9 is a schematic circuit diagram showing a part of a second embodiment of the electric power circuit for driving a display panel according to the present invention;

FIG. 10 is a schematic circuit diagram showing a part of the second embodiment; and

FIG. 11 is a schematic circuit diagram showing a part of the second embodiment;

### DETAILED DESCRIPTION OF THE INVENTION

### First Embodiment

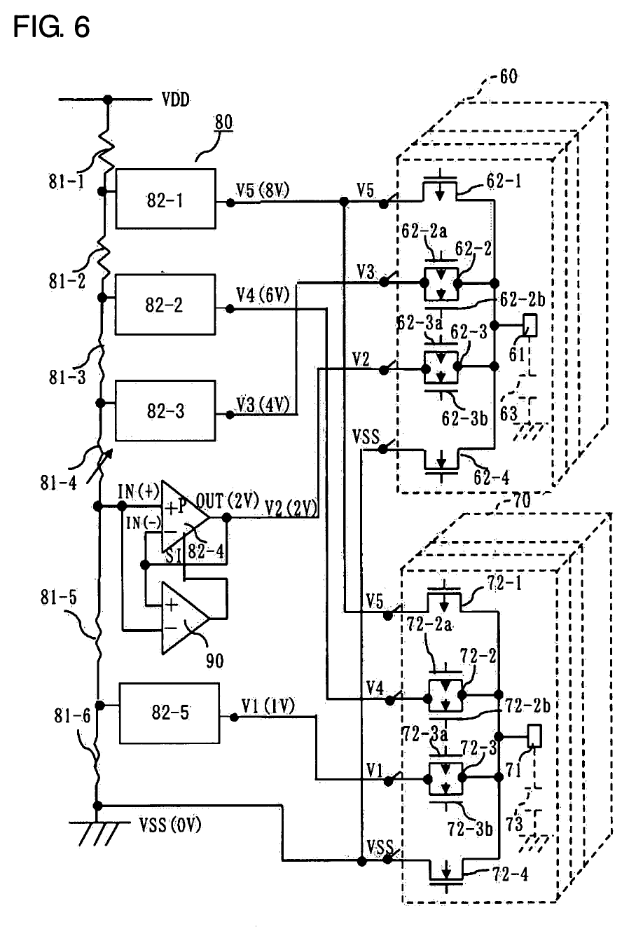

A first embodiment of the electric power circuit for driving a display panel according to the present invention will now be described with reference to FIG. 6 to 8. FIG. 6 is a block diagram showing a first embodiment of the electric power circuit for driving a display panel according to the present invention. In FIG. 6, a driver IC having one hundred EG driver parts 60 and one hundred COM driver parts 70 and an electric power circuit 80 for supplying a plurality of gradation voltages to each of the SEG and COM driver parts 60, 70 are illustrated.

Each of the SEG driver part 60 has four switches and a SEG terminal 61 connected to the four switches. The four switches, which are connected in parallel to each other, selectively supply gradation voltages generated by the electric power circuit 80 to the SEG terminal 61. The four switches are configured by a PMOS 62-1, an analogue switch 62-2 having a PMOS 62-2a and an NMOS 62-2b, an analogue switch 62-3 having a PMOS 62-3a and an NMOS 62-3b, and an NMOS 62-4.

The PMOS 62-1 operates as a switch for supplying a gradation voltage having a level of V5(=8V) to the SEG terminal 61. The analogue switch 62-2 operates as a switch for supplying a gradation voltage of V3(=4V) to the SEG terminal 61. The analogue switch 62-3 operates as a switch for supplying a gradation voltage of V2(=2V) to the SEG terminal 61. The NMOS 62-4 operates as a switch for supplying a gradation voltage of VSS(=0V) to the SEG terminal 61. On/off operations of the PMOS 62-1, the analogue switches 62-2, 62-3, and the NMOS 62-4 are controlled by a controlling circuit (not shown). The SEG terminals 61 are respectively connected to load carrying capacities 63 of the STN liquid crystal display panel.

Each of the COM driver part 70 has four switches and a COM terminal 71 connected to the four switches. The four switches, which is connected in parallel to each other, selectively supply gradation voltages generated by the electric power circuit 80 to the COM terminal 71. The four switches are configured by a PMOS 72-1, an analogue switch 72-2 having a PMOS 72-2a and an NMOS 72-2b, an analogue switch 72-3 having a PMOS 72-3a and an NMOS 72-3b, and an NMOS 72-4, respectively.

The PMOS 72-1 operates as a switch for supplying the gradation voltage V5(=8V) to the COM terminal 71. The analogue switch 72-2 operates as a switch for supplying a gradation voltage of V4(=6V) to the COM terminal 71. The analogue switch 72-3 operates as a switch for supplying a gradation voltage of V1(=1V) to the COM terminal 71. The NMOS 72-4 operates as a switch for supplying the gradation voltage VSS(=0V) to the COM terminal 71. On/off switching operations of the PMOS 72-1, the analogue switches 72-2, 72-3, and the NMOS 72-4 are controlled by the controlling circuit (not shown in FIG). The COM terminals 61 are respectively connected to load carrying capacities 73 of the STN liquid crystal display panel.

The electric power circuit 80 supplies the gradation voltages V5, V3, V2 and VSS to the SEG driver part 60 and supplies the gradation voltages V5, V4, V1, and VSS to the COM part 70. The electric power circuit 80 includes six resistors 81-1 to 83-6 connected in series across an electric power terminal (hereafter “VDD” terminal) and an earth terminal (hereafter “VSS” terminal), to which an electric power-supply voltage VDD and an earth voltage VSS (=0V) are respectively applied. The resistors 81-1 to 81-6 are utilized for respectively generate intermediate voltages necessary to drive the STN liquid crystal panel. The electric power circuit 80 also has five operational amplifiers (hereafter “op-amps”) 82-1 to 82-5. Each of the op-amps 82-1 to 82-5 operates as a voltage follower in response to the intermediate voltage between two adjoined resistors among the six resistors 81-1 to 81-6 and the gradation voltage so as to decrease an output impedance.

The op-amps 82-1, 82-2, and 82-4, which generate the gradation voltages of V5, V4, and V2 respectively, are configured as PMOS buffer op-amps, each having a PMOS buffer for generating a gradation voltage. The op-amps 82-1, 82-2, and 82-4 are designed to correspond with a large load. The op-amps 82-3 and 82-5, which generates the gradation voltages of V3 and V1 respectively, are configured as NMOS buffer op-amps, each having an NMOS buffer for generating a gradation voltage. The op-amps 82-3 and 82-5 are designed to correspond with a small load and decrease electric current consumption.

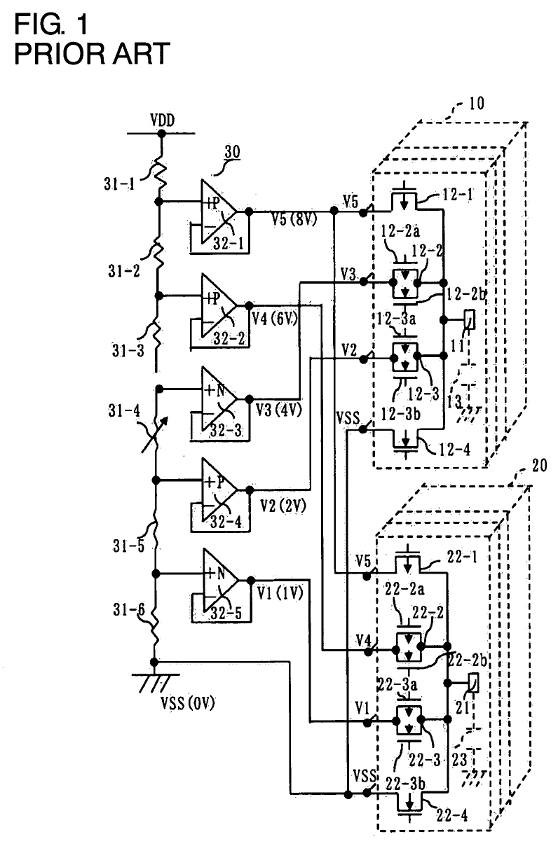

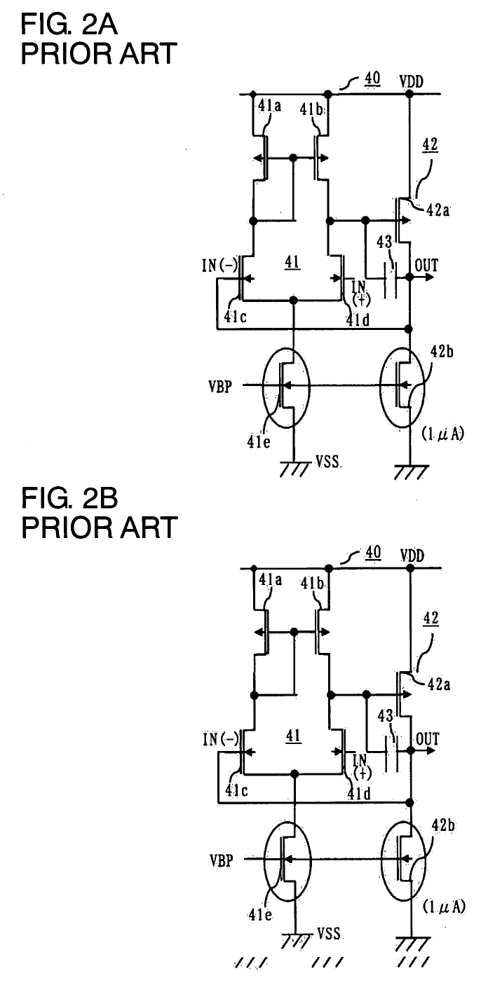

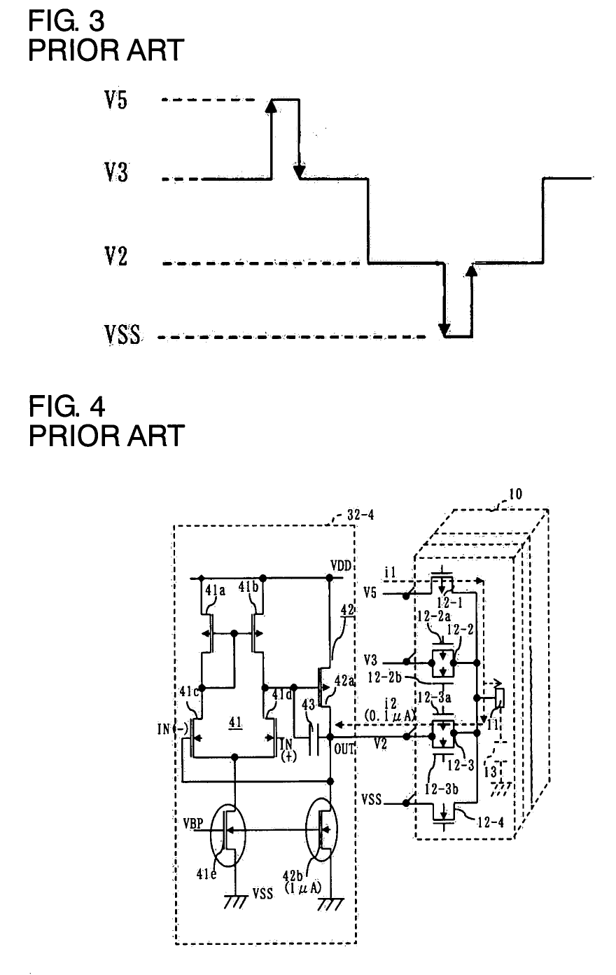

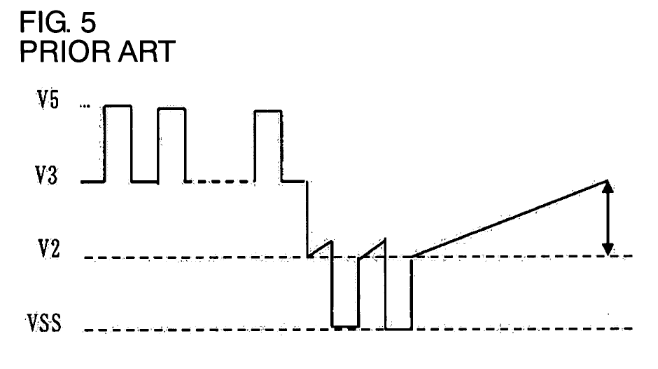

In the first embodiment, the op-amp 82-4 generating the gradation voltage of V2 is configured as a push-pull op-amp (hereafter “push-pull PMOS buffer op-amp”) having a PMOS buffer. In addition, the push-pull PMOS buffer op-amp 82-4 is connected to a hysteresis comparator 90, which is one of analogue comparators, for generating a stable power output even if input signals, on which noises are superimposed, are supplied. The first embodiment shown in FIG. 6 is different from the conventional electric power supply circuit of FIG. 1 in the point of the push-pull PMOS buffer op-amp 82-4 and the hysteresis comparator 90.

The push-pull PMOS buffer op-amp 82-4 has positive input terminal IN(+), negative input terminal IN(−), a control terminal SI, and an output terminal OUT(V2). The positive input terminal IN(+) is connected to an intermediate voltage across the resistors 81-4 and 81-5. The output terminal OUT(V2), from which the gradation voltage of V2 is generated, is feedbacked to the negative input terminal IN(−). The positive input terminal IN(+) of the push-pull PMOS buffer op-amp 82-4 is also connected to a negative input terminal of the hysteresis comparator 90. The negative input terminal IN(−) of the push-pull PMOS buffer op-amp 82-4 is also connected to a positive input terminal of the hysteresis comparator 90. An output terminal of the hysteresis comparator 90 is connected to the control terminal SI of the push-pull PMOS buffer op-amp 82-4.

The hysteresis comparator 90, having positive and negative input terminals and an output terminal, is configured so as to generate high (“H”) or low (“L”) level comparative signals in response to a voltage difference between input voltages applied to the positive and negative input terminals thereof. In addition, the hysteresis comparator 90 has a hysteresis property, thus performing different operations when the gradation voltage increases and decreases. For example, it is configured in accordance with a specification value of voltage variation (30 mV) that a high threshold voltage of VTH is V2+30 mV, a low threshold voltage of VLH is V2, and a difference between the high and low threshold voltages (corresponding to a hysteresis) is 30 mV. The hysteresis comparator 90 generates a “H” level signal at the high threshold voltage of V2+VTH when the gradation voltage increases, whereas the hysteresis comparator 90 generates a “L” level signal at the low threshold voltage of V2 when the gradation voltage decreases. The push-pull PMOS buffer op-amp 82-4 operates as a PMOS buffer type op-amp in response to a “L” level comparative signal from the hysteresis comparator 90 to the control terminal SI thereof, and operates as a push-pull PMOS buffer type op-amp in response to a “H” level comparative signal.

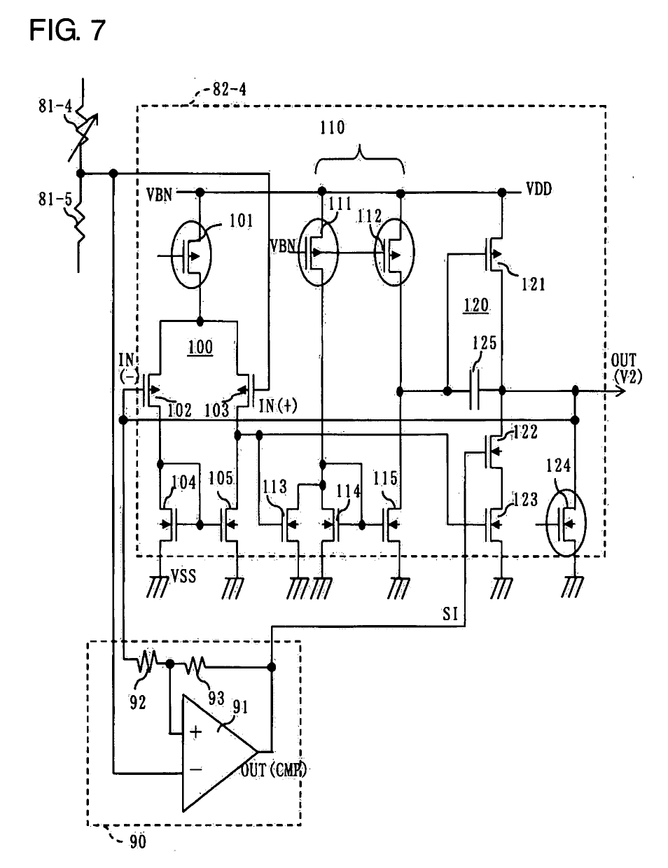

FIG. 7 is a circuit diagram showing a main part of the push-pull PMOS buffer op-amp 82-4 and the hysteresis comparator 90 of FIG. 6.

The push-pull PMOS buffer op-amp 82-4 has a differential amplification stage 100, a level shift stage 110, and an output stage 120. The differential amplification stage 100 has positive and negative input terminals IN(+) and IN(−). The positive input terminal IN(+) is connected to the intermediate voltage across the resistors 81-4 and 81-5. The negative input terminal IN(−) is connected to a gradation voltage on an output terminal OUT(V2). The differential amplification stage 100 inputs input voltages supplied to the positive and negative input terminals IN(+) and IN(−) and generates a differential output voltage corresponding to a difference between the input voltages. The level shift stage 110 generates an output voltage which varies in response to the differential output voltage of differential amplification stage 100. In response to the output voltage, the output stage 120 produces a gradation voltage to the output terminal OUT(V2).

The differential amplification stage 100 includes a PMOS 101, a differential input pair of PMOS's 102, 103, and a current mirror pair of NMOS's 104, 105. The PMOS 101 operates as a constant current source which flows a substantially constant electric current to the differential input pair of the PMOS's 102 and 103 in response to the bias voltage VBN. The PMOS 101 has a gate terminal to which the bias voltage is applied and a source terminal connected to the VDD terminal. The PMOS 101 also has a drain terminal connected to source terminals of the differential input pair of the PMOS's 102, 103. The differential input pair of the PMOS's 102, 103 are respectively gate-controlled in response to the input voltages from the negative input terminal IN(−) and the positive input terminal IN(+), respectively. A drain terminal of the PMOS 102 is connected to a drain terminal of the NMOS 104 and gate terminals of the current mirror pair of NMOS's 104, 105. A drain terminal of the PMOS 103 is connected to a drain terminal of the NMOS 105. Source terminals of the current mirror pair of NMOS's 104, 105 are connected to the VSS terminal.

The level shift stage 110 has a pair of PMOS 111, 112, a current mirror pair of NMOS's 114, 115, and an NMOS 113. The pair of PMOS 111, 112, each operating as a constant current source, flow substantially constant electric currents to the current mirror pair of NMOS's 114, 115 in response to the bias voltage VBN. Each of the pair of PMOS 111, 112 has a source terminal connected to the VDD terminal and also has a gate terminal to which the bias voltage VBN is applied. Drain terminals of the PMOS 111 is connected to drain terminals of the NMOS's 113,114, and also connected to gate terminals of the current mirror pair of NMOS's 114, 115. A drain terminal of the PMOS 112 is connected to a drain terminal of the NMOS 115. Source terminals of the NMOS's 113 to 115 are connected to the VSS terminal. The current mirror pair of the NMOS's 114, 115 operates as a current mirror circuit flowing substantially the same electric current to the VSS terminal. The drain terminal of the NMOS 113 is controlled by the differential output voltage supplied from the differential amplification stage 100.

The output stage 120 includes a PMOS 121, an NMOS 122, an NMOS 123, an NMOS 124, and a capacitor 125. The PMOS 121, which operates as a PMOS buffer, generates a gradation voltage in response to the output voltage of the level shift stage 110. The PMOS 121 has a source terminal connected to the VDD terminal, a drain terminal connected to the output terminal OUT(V2), and a gate terminal to which the output voltage generated by the level shift stage 110 is applied. An electric current through the PMOS 121 is controlled by the output voltage of the level shift stage 110. The NMOS 122 operates as a switch which is turned on/off in response to a comparative signal generated by the hysteresis comparator 90. The NMOS 122 has a drain terminal connected to the output terminal OUT(V2), a source terminal connected to a drain terminal of the NMOS 123, and a gate terminal connected to the control terminal SI. The NMOS 122 is gate-controlled in response to the comparative signal generated by the hysteresis comparator 90. The NMOS 123 is utilized for fine-controlling the gradation voltage on the output terminal OUT(V2) when the NMOS 122 is turned on. The NMOS 123 is gate-controlled by the differential output voltage generated by the differential amplification stage 100. The NMOS 124 has a drain terminal connected to the output terminal OUT(V2), a source terminal connected to the VSS terminal, and a gate terminal to which the bias voltage VBP is applied. The NMOS 124 operates as a constant current source flowing a substantially constant electric current to the VSS terminal. The capacitor 125 connected across the drain and gate terminals of the PMOS 121 stabilizes the gradation voltage of V2.

A series circuit of the NMOS's 122, 123 and the NMOS 124 configures the fine-controlling part according to the present invention.

The hysteresis comparator 90 includes an op-amp 91 and resistors 92, 93. The op-amp 91 has positive and negative input terminals and an output terminal (CMP). The op-amp 91 inputs the intermediate voltage across the resistors 81-4 and 81-5 as an input signal from the negative input terminal. The op-amp 91 also inputs the gradation voltage on the output terminal OUT(V2) as a referential signal from the positive input terminal via the resistor 92. The resistor 93 is connected across the positive input terminal and the output terminal (CMP). The op-amp 91 outputs a comparative signal to the control terminal SI.

A typical comparator having only an op-amp generates “H” or “L” level comparative signals in response to a difference between a referential voltage supplied to a positive input terminal thereof and an input voltage supplied to a negative input terminal thereof. In the typical comparator, if noises are superimposed on the input voltage, “H” or “L” level comparative signals are repeatedly generated in a state that the difference between the reference voltage and input voltage is relatively small, thus destabilizing the comparative signal. In the first embodiment, the hysteresis comparator 90 has the resistors 92, 93 connected to the op-amp 91 so as to generate a stable comparative signal. The resistors 92, 93 provide a hysteresis property to the op-amp 91. The hysteresis comparator 90 has high and low threshold voltages VTH, VTL, a difference of which corresponds to a hysteresis and are determined from a ratio of resistances of the resistors 92, 93. At the time when the gradation voltage on the output terminal OUT(V2) increases to the high threshold voltage of VTH, the hysteresis comparator 90 generates a “H” level comparative signal at VTH. At the time when the increased gradation voltage on the output terminal OUT(V2) decreases to the low threshold voltage of VTL, the hysteresis comparator 90 generates a “L” level comparative signal at VTL. Therefore, the hysteresis comparator 90 can generate a stable comparative signal even if it receives the input voltages on which noises are superimposed.

The electric power circuit 80 supplies the gradation voltages V2, V3, and V5 to the SEG driver part 60, and supplies the gradation voltages V1, V4, and V5 to the COM driver part 70. On/off switching operations of the PMOS 62-1, the analogue switches 62-2, 62-3, and the NMOS 62-4 of the SEG driver part 60 are controlled in response to display controlling signals generated by the controlling circuit (not shown). On/off switching operations of the PMOS 72-1, analogue switches 72-2, 72-3, and the NMOS 72-4 of the COM driver part 70 are also controlled in response to display controlling signals generated by the controlling circuit (not shown). The gradation voltages V5, V3, V2, and VSS, whose timings are dependent upon predetermined timing of the display controlling signals, are selectively supplied from the SEG terminal 61, and the gradation voltages V5, V4, V1, and VSS, whose timings are dependent upon predetermined timings of the display controlling signals, is supplied from the COM terminal 71. The STN liquid crystal display panel is driven by the gradation voltages from the SEG terminals and COM terminals.

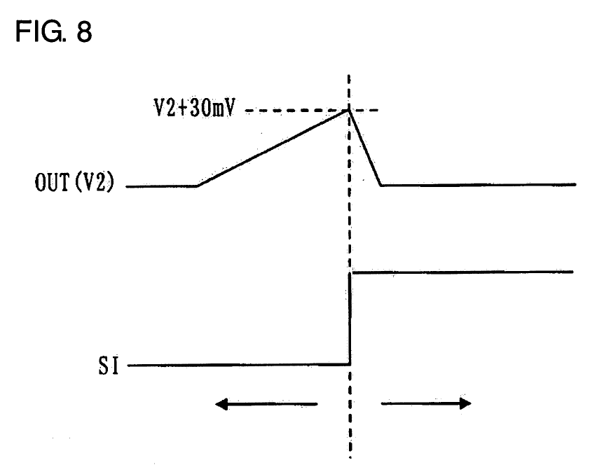

FIG. 8 is a waveform chart showing operations of the push-pull PMOS buffer op-amp 82-4 and the hysteresis comparator 90 of FIG. 7. An upper waveform chart of FIG. 8 represents a gradation voltage on the output terminal OUT(V2) in response to a comparative signal of the control terminal SI in a lower waveform chart of FIG. 8.

Operations of the of the push-pull PMOS buffer op-amp 82-4 and the hysteresis comparator 90 will now be described with reference to FIG. 8 in view of voltage levels of the gradation voltage on the output terminal OUT(V2). In the following description of the first embodiment, a first gradation voltage level is defined as a level in which a gradation voltage on the output terminal OUT(V2) is lower than the low threshold voltage of VTL. A second gradation voltage level is defined as a level in which a gradation voltage on the output terminal OUT(V2) is in the range from the low threshold voltage of VTL to the high threshold voltage of VTH. A third gradation voltage level is defined as a level in which a gradation voltage on the output terminal OUT(V2) is more than VTH. As shown in FIG. 8, VTL is V2 and VTH is V2+30 mV.

In the first gradation voltage level in which a gradation voltage on the output terminal OUT(V2) is less than the low threshold voltage of V2, the hysteresis comparator 90 generates a “L” level comparative signal to the control terminal SI of the push-pull PMOS buffer op-amp 82-4, so that the NMOS 122 of the output stage 124 of the push-pull PMOS buffer op-amp 82-4, whose gate terminal is controlled by the comparative signal, is turned off. Since the gradation voltage decreases, an electric current through the PMOS 102 increases, and thus an electric current through the NMOS 104 increases. A mirror electric current through the NMOS 105 also increases, thus the differential amplification stage 100 outputs a decreased differential output voltage to the gate terminal of the NMOS's 113 and 123. In response to the decreased differential output voltage, electric currents through the NMOS 113 decrease. Since the electric current through the NMOS 113 decreases, an electric current though the NMOS 114 increases. A mirror electric current though the NMOS 115 also increases, thus the level shift state 110 generating a decreased output voltage to the gate terminal of the PMOS 121. In response to the decreased output voltage, the gate of the PMOS 121 is largely opened, and thus an electric current through the PMOS 121 increases. Since the NMOS 122 is in an off-state, the NMOS 123 does not operate. In this way, the gradation voltage increases so as to be V2 level. In the first gradation voltage level, the NMOS 122 is in an off-state, and thus the push-pull PMOS buffer op-amp 82-4 operates as a PMOS buffer type op-amp whose gradation voltage is generated by the PMOS 121.

In a state that a gradation voltage is substantially same as the reference voltage V2, the hysteresis comparator 90 generates a “L” level comparative signal to the control terminal SI of the push-pull PMOS buffer op-amp 82-4. In response to the “L” level comparative signal, the NMOS 122 of the output stage 124 of the push-pull PMOS buffer op-amp 82-4 is turned off, so that the NMOS 123 does not operate. Therefore, the push-pull PMOS buffer op-amp 82-4 operates as a PMOS buffer type op-amp whose gradation voltage is generated by the PMOS 121. In this case, the PMOS 121 operates as a PMOS buffer and the NMOS 124 operates as a constant current source.

When the push-pull PMOS buffer op-amp 82-4 operates as the PMOS buffer type op-amp, the differential amplification stage 100 generates a differential output voltage corresponding to a difference between the intermediate voltage across the two resistors 81-4, 81-5 and the gradation voltage on the output terminal OUT(V2). In response to the differential output voltage, the level shift stage 110 generates an output voltage. In response to the output voltage generated by the level shift stage 110, the PMOS 121 is gate-controlled so as to generate the gradation voltage of V2. In this way, the push-pull PMOS buffer op-amp 82-4 is feedback-controlled so that the difference between the intermediate voltage and the gradation voltage is substantially zero. Therefore, the push-pull PMOS buffer op-amp 82-4 is capable of generating a stable gradation voltage to the SEG terminals 61 of the SEG driving part 60 via the analogue switch 62-3. The push-pull PMOS buffer op-amp 82-4 operates as the PMOS buffer type op-amp, thus decreasing electric current consumption.

In the second gradation voltage level in which a gradation voltage on the output terminal OUT(V2) is in the range from the low threshold voltage of V2 to the high threshold voltage of V2+30 mV, the push-pull PMOS buffer op-amp 82-4 and the hysteresis comparator 90 operates in two ways because the hysteresis comparator 90 has the hysteresis property. When a gradation voltage increases in the second gradation voltage level, the hysteresis comparator 90 generates a “L” level comparative signal. When a gradation voltage decreases in the second gradation voltage level, on the other hands, the hysteresis comparator 90 generates a “H” level comparative signal.

When a gradation voltage increases in the second gradation voltage level, the hysteresis comparator 90 generates a “L” level comparative signal. The hysteresis comparator 90 generates a “L” level comparative signal to the control terminal SI of the push-pull PMOS buffer op-amp 82-4, so that the NMOS 122 of the output stage 124 of the push-pull PMOS buffer op-amp 82-4, whose gate terminal is controlled by the comparative signal, is turned off. Since the gradation voltage increases, an electric current through the PMOS 102 decreases, and thus an electric current through the NMOS 104 decreases. A mirror electric current through the NMOS 105 also decreases, thus the differential amplification stage 100 outputs an increasing differential output voltage to the gate terminal of the NMOS's 113 and 123. In response to the increasing differential output voltage, an electric currents through the NMOS 113 increase. Since the electric current through the NMOS 113 increases, an electric current though the NMOS 114 decreases. A mirror electric current though the NMOS 115 also decreases, thus the level shift state 110 generating an increasing output voltage to the gate terminal of the PMOS 121. In response to the increasing output voltage, the gate of the PMOS 121 is slightly opened, and thus an electric current through the PMOS 121 decreases. Since the NMOS 122 is turned off, the NMOS 123 does not operate. In this way, the gradation voltage decreases so as to be V2 level. In the second gradation voltage level at the time when the gradation voltage increases, the NMOS 122 is in an off-state, and thus the push-pull PMOS buffer op-amp 82-4 operates as a PMOS buffer type op-amp whose gradation voltage is generated by the PMOS 121.

When a gradation voltage decreases in the second gradation voltage level, the hysteresis comparator 90 generates a “H” level comparative signal. The hysteresis comparator 90 generates a “H” level comparative signal to the control terminal SI of the push-pull PMOS buffer op-amp 82-4, so that the NMOS 122 of the output stage 124 of the push-pull PMOS buffer op-amp 82-4, whose gate terminal is controlled by the comparative signal, is turned on. Since the gradation voltage decreases, an electric current through the PMOS 102 increases, and thus an electric current through the NMOS 104 increases. A mirror electric current through the NMOS 105 also increases, thus the differential amplification stage 100 outputs a decreasing differential output voltage to the gate terminal of the NMOS's 113 and 123. In response to the decreasing differential output voltage, electric currents through the NMOS 113 and NMOS 123 decrease. Since the electric current through the NMOS 113 decreases, an electric current though the NMOS 114 increases. A mirror electric current though the NMOS 115 also increases, thus the level shift state 110 generating an decreasing output voltage to the gate terminal of the PMOS 121. In response to the decreasing output voltage, the gate of the PMOS 121 is largely opened, and thus an electric current through the PMOS 121 increases. Since the NMOS 122 is in the on-state, the NMOS 123 operates. In this way, the gradation voltage decreases so as to be V2 level. In the second gradation voltage level at the time when the gradation voltage decreases, the NMOS 122 is in the on-state, and thus the push-pull PMOS buffer op-amp 82-4 operates as a push-pull PMOS buffer type op-amp whose gradation voltage is generated by the PMOS 121 and controlled by the NMOS 123 via the NMOS 122.

When the gradation voltage changes from the second gradation voltage level to the third gradation voltage level as shown in FIG. 8, the hysteresis comparator 90 generates a “H” level comparative signal to the control terminal SI of the push-pull PMOS buffer op-amp 82-4. The NMOS 122 of the output stage 124 of the push-pull PMOS buffer op-amp 82-4, whose gate terminal is controlled by the comparative signal, is turned on, thus increasing an electric current from the output terminal OUT(V2) to the NMOS 123. The NMOS 123 also operates in response to a differential output voltage generated by the differential amplification stage 100. Therefore, the push-pull PMOS buffer op-amp 82-4 operates as the push-pull PMOS buffer type op-amp whose gradation voltage is generated by the PMOS 121 and controlled by the NMOS 123. The PMOS 121 operates as a PMOS buffer and the NMOS 123 operates as an NMOS buffer. It should be noted that the NMOS 124, which also operates at the time of the push-pull operation of the output stage 120, does not affect the push-pull operation.

When the push-pull PMOS buffer op-amp 82-4 operates as the PMOS buffer type op-amp, the differential amplification stage 100 generates a differential output voltage corresponding to a difference between the intermediate voltage across the resistors 81-4, 81-5 and the gradation voltage on the output terminal OUT(V2). The level shift stage 110 generates an output voltage to the gate terminal of the PMOS 121. The PMOS 121 and the NMOS 123, which is push-pull connected via the NMOS 122, are gate-controlled so as to generate the gradation voltage in the range from V2 (low threshold voltage) to V2+30 mV (high threshold voltage) in response to the differential output voltage supplied from the differential amplification stage 100 and the output voltage supplied from the level shift stage 110. In this way, the push-pull PMOS buffer op-amp 82-4 is feedback-controlled so that the difference between the intermediate voltage and the gradation voltage is substantially zero. Therefore, the push-pull PMOS buffer op-amp 82-4 is capable of generating stable gradation voltage of V2 to the SEG terminals 61 of the SEG driving parts 60 via the analogue switch 62-3. The push-pull PMOS buffer op-amp 82-4 also operates as the PMOS buffer type op-amp, thus decreasing electric current consumption of the electric power circuit.

According to the first embodiment, the hysteresis comparator 90 generates a “H” level comparative signal if a gradation voltage increases and a difference between the gradation voltage is higher than the difference between the high threshold voltage VTH and low threshold voltage VTL. The increase of the gradation voltage occurs due to, for example, a leakage electric current through the PMOS 62-1 of the SEG driver part 60 at high temperature. In response to the “H” level comparative signal, the push-pull PMOS buffer op-amp 82-4 generates the push-pull output voltage whose voltage level is appropriately controlled to be V2 so as to suppress the increasing gradation voltage.

### Second Embodiment

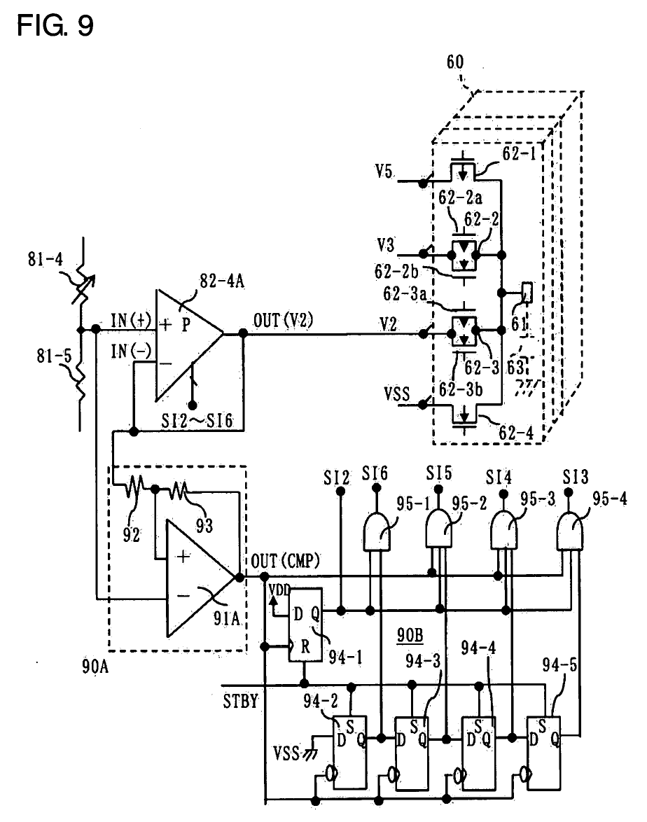

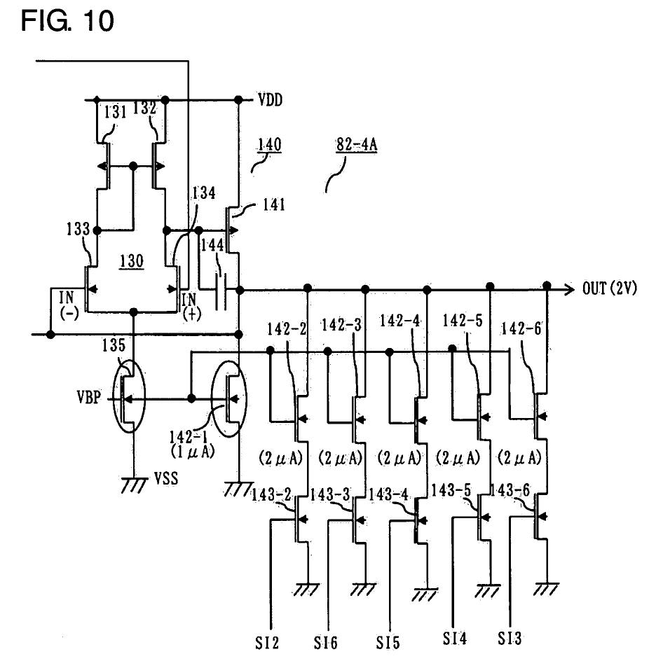

A second embodiment of the electric power circuit for driving a display panel according to the present invention is described with reference to FIGS. 9 to 11. In similar to the first embodiment, the second embodiment is configured by a reference voltage generation circuit having six resistors and five operational amplifiers. The reference voltage generation circuit is connected across VDD and VSS terminals, to which a voltage of VDD and an earth voltage VSS are supplied respectively. Intermediate voltages across two adjacent resistors among the six resistors are respectively connected to the five operational amplifiers. The second embodiment supplies gradation voltages to a driver IC including one hundred SEG driver parts 60 and one hundred COM driver parts 70 so as to drive a STN liquid display panel. FIG. 9 is a schematic circuit diagram showing a main part of the second embodiment of the electric power circuit for driving a display panel. FIG. 10 is a schematic circuit diagram showing a PMOS buffer op-amp of FIG. 9. In FIG. 9, elements operating in the same way as those of the first embodiment of FIG. 7 are denoted by the same numerals.

As shown in FIG. 9, the second embodiment includes a PMOS buffer type op-amp 82-4A and a comparator having a hysteresis comparator 90A with an offset function and a control signal generation circuit 90B, which respectively corresponds to the push-pull PMOS buffer op-amp 82-4 and the hysteresis comparator 90 of the electric power circuit 80 in the first embodiment.

In the second embodiment, the hysteresis comparator 90A with an offset function receives input and output voltage of the PMOS buffer type op-amp 82-4A and generates a comparative signal. In response to the comparative signal, the control signal generation circuit 90B generates control signals to control terminals SI 2 to 6 of the PMOS buffer type op-amp 82-4A.

As shown in FIG. 10, the PMOS buffer op-amp 82-4A has a differential amplification stage 130 and an output stage 140. The differential amplification stage 130 inputs an intermediate voltage across the resistors 81-4, 81-5 and a gradation voltage on the output terminal OUT(V2), which voltages are supplied from a positive input terminal IN(−) and a negative input terminal IN(+), respectively. The differential amplification stage 100 generates a differential output voltage corresponding to a difference between the intermediate voltage and the gradation voltage. In response to the differential output voltage, the output stage 140 generates a gradation voltage to the output terminal OUT(V2).

The differential amplification stage 130 has a current mirror pair of PMOS's 131, 132, a differential input pair of NMOS's 133, 134, and an NMOS 135. The current mirror pair of PMOS's 131, 132 have respective source terminals connected to a VDD terminal and also have respective gate terminals connected to each other. The current mirror pair of PMOS's 131, 132 configures a current mirror circuit. The NMOS 133 has a drain terminal connected to the drain and gate terminals of the PMOS 131. The NMOS 133 is gate-controlled by the gradation voltage on the output terminal OUT(V2) via the negative input terminal IN(−). The NMOS 134 has a drain terminal connected to the drain terminal of the PMOS 132. The NMOS 134 is gate-controlled by the intermediate voltage across the resistors 81-4 and 81-5 via the positive input terminal IN(+). The NMOS 135 is connected across source terminals of the differential input pair of NMOS's 133, 134 and a VSS terminal. The NMOS 135 operates as a constant electric current source flowing a substantially constant electric current to the VSS terminal in response to a bias voltage VBP.

The output stage 140 has a PMOS 141, an NMOS 142-1, and a plurality of series circuits. The PMOS 141 operates as a PMOS buffer transistor. The NMOS 142-1 operates as a constant current source flowing a substantially constant electric current (for instance, 1 μA) to the VSS terminal in response to the bias voltage VBP. The PMOS 141 and the NMOS 142-1 are connected in series across the VDD and VSS terminals. The plurality of series circuits are connected in parallel to the NMOS 142-1.

The plurality of series circuits are configured by NMOS's 142-2 to 142-6 and NMOS's 143-2 to 143-6 connected in series to the NMOS's 142-2 to 142-6, respectively. Each of the NMOS's 142-2 to 142-6 operates as a constant current source flowing a substantially constant electric current (for instance, 2 μA) to each of the NMOS's 143-2 to 143-6. Each of the NMOS's 143-2 to 143-6 operates a switch relaying the constant electric current supplied from each of the NMOS's 142-2 to 142-6 to the VSS terminal. On/off operations of the NMOS's 143-2 to 143-6 are controlled by the corresponding control signals via the control terminals SI 2 to 6, respectively.

The PMOS 141 operating as a PMOS buffer is gate-controlled by a source voltage of the NMOS 132. The NMOS 141-1 to 141-6, each operating as a constant current source, are gate-controlled by the bias voltage VBP. The capacitor having a predetermined capacitance (for example, 0.1 μF) is connected between the drain and gate terminals of the PMOS 141 for stabilizing the gradation voltage on the output terminal OUT(V2).

The hysteresis comparator 90A is configured by an op-amp 91A and two resistors 92 and 93 as shown in FIG. 9. The hysteresis comparator 90A is configured so as to have a hysteresis property in which high and low threshold voltages VTH, VTL are V2+30 meV and V2+10 meV, respectively. A difference between the high and low threshold voltages, which corresponds to a hysteresis width VH, is 20 meV and an offset voltage 10 meV. Therefore, if the gradation voltage on the output terminal OUT(V2) increases to the high threshold voltage of V2+30 meV, the hysteresis comparator 90A generates a “H” level comparative signal. If the gradation voltage on the output terminal OUT(V2) decreases to the low threshold voltage of V2+10 meV, the hysteresis comparator 90A generates a “L” level comparative signal.

The control signal generation circuit 90B stops its operation in response to a “H” level standby signal STBY generated by a standby signal generation circuit (not shown) and starts its operation in response to a “L” level standby signal STBY. In response to a comparative signal supplied from the hysteresis comparator 90A via the output terminal OUT(CMP), the control signal generation circuit 90B generates control signals at predetermined timings to the control terminals SI 2 to SI 6 of the PMOS buffer type op-amp 82-4A.

The control signal generation circuit 90B includes a first flip-flop (FF) 94-1, second to fifth FF's 94-2 to 94-5, and AND gates 95-1 to 95-4. In response to a “L” level standby signal STBY, the first FF 94-1 holds a comparative signal on the output terminal OUT(CMP). In response to a “H” level standby signal STBY, the first FF 94-1 resets the comparative signal. In response to a “L” level standby signal STBY, the second to fifth FF's 94-2 to 94-5 respectively holds comparative signals. In response to the “H” level standby signal STBY, the second to fifth FF's 94-2 to 94-5 reset the respective comparative signals. The AND gate 95-1 perform a logical AND operation between outputs of the first and second FF's 94-1, 94-2. The AND gate 95-2 perform a logical AND operation between a comparative signal on the output terminal OUT(CMP) and outputs of the first and third FF's 94-1, 94-3. The AND gate 95-3 perform a logical AND operation between a comparative signal on the output terminal OUT(CMP) and outputs of the first and fourth FF's 94-1, 94-4. The AND gate 95-4 perform a logical AND operation between a comparative signal on the output terminal OUT(CMP) and outputs of the first and fifth FF's 94-1, 94-5. An output terminal of the first FF 94-1 is connected to the control terminal SI 2. Output terminals of the AND gates 95-1 to 95-4 are connected to the control terminal SI 6 to 3, respectively.

In response to a “L” level comparative signal of the hysteresis comparator 90A, the control signal generation circuit 90B generates “L” level control signals to the control terminals SI 2 to SI 6 of the PMOS buffer op-amp 82-4A. In response to the “L” level control signals, the NMOS's 143-2 to 143-6 of the PMOS buffer op-amp 82-4A, each operating as a constant current source, are turned off, thus the gradation voltage on the output terminal OUT(V2) is fine-controlled by only the NMOS 142-1 operates. In response to a “H” level comparative signal of the hysteresis comparator 90A, the control signal generation circuit 90B generates “H” level control signals to the PMOS buffer op-amp 82-4A. In response to the “H” level control signals, the NMOS's 143-2 to 143-6 of the PMOS buffer op-amp 82-4A are turned on. Thus, the gradation voltage on the output terminal OUT(V2) is fine-controlled by the NMOS's 142-1 to 142-6. It should be noted that the control signal generation circuit 90B selectively generates “H” or “L” level control signals in response to the “H” level comparative signal as shown in FIG.

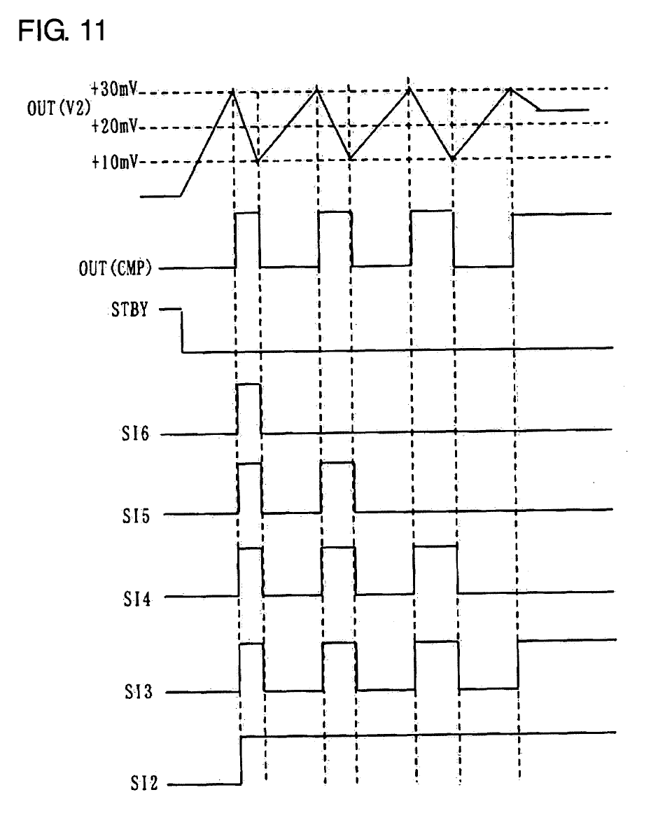

FIG. 11 illustrates timing charts showing operation of the electric power circuit shown in FIGS. 9 and 10. In FIG. 11, a gradation voltage on the output terminal OUT(V2) is changed to a stable voltage by selectively turning on/off the NMOS's 142-2 to 142-6.

Operations of the push-pull PMOS buffer op-amp 82-4A and the hysteresis comparator 90A will now be described with reference to FIG. 11 in view of voltage levels of the gradation voltage on the output terminal OUT(V2). In the following description of the second embodiment, a first gradation voltage level is defined as a level in which a gradation voltage on the output terminal OUT(V2) is lower than the low threshold voltage of VTL. A second gradation voltage level is defined as a level in which a gradation voltage on the output terminal OUT(V2) is in the range from the low threshold voltage of VTL to the high threshold voltage of VTH. A third gradation voltage level is defined as a level in which a gradation voltage on the output terminal OUT(V2) is more than VTH. As shown in FIG. 11, VTL is V2+10 meV and VTH is V2+30 mV.

In the first gradation voltage level, the hysteresis comparator 90A generates a “L” comparative signal, and thus the control signal generation circuit 90B generates “L” level control signals to the control terminals SI 2 to SI 6 of the PMOS buffer op-amp 82-4A. In response to the “L” level control signals, the NMOS's 143-2 to 143-6 operating as a switch are turned off. The differential amplification stage 130 generates a difference output voltage corresponding to a difference between the intermediate voltage and the gradation voltage to the gate terminal of the PMOS 141. In response to the differential output voltage, an electric current through the PMOS 141 increases and decreases so as to generate a gradation voltage of V2. It should be noted that the PMOS 141 increases the electric current therethrough when the gradation voltage is lower than the intermediate voltage and decreases the electric current therethrough when the gradation voltage is higher than the intermediate voltage.

When the gradation voltage on the output terminal OUT(V2) is same as the intermediate voltage, the hysteresis comparator 90A generates a “L” level comparative signal to the control signal generation circuit 90B. In response to the “L” level comparative signal, the control signal generation circuit 90B generates “L” level control signals to the control terminals SI 2 to SI 6 of the PMOS buffer op-amp 82-4A. Since the gradation voltage is higher than the intermediate voltage, the PMOS 141 decreases an electric current therethrough. Thus, the gradation voltage is fine-controlled by the NMOS 142-1 so that the gradation voltage is V2 level.

In the second gradation voltage level in which a gradation voltage on the output terminal OUT(V2) is in the range from the low threshold voltage of V2+10 mV to the high threshold voltage of V2+30 mV, the push-pull PMOS buffer op-amp 82-4A and the hysteresis comparator 90A operates in two ways because the hysteresis comparator 90A has the hysteresis property. When a gradation voltage increases in the second gradation voltage level, the hysteresis comparator 90A generates a “L” level comparative signal. When a gradation voltage decreases in the second gradation voltage level, on the other hands, the hysteresis comparator 90 generates a “H” level comparative signal.

When a gradation voltage increases in the second gradation voltage level, the hysteresis comparator 90A generates a “L” level comparative signal, and thus the control signal generation circuit 90B generates “L” level control signals to the control terminals SI 2 to SI 6 of the PMOS buffer op-amp 82-4A. In response to the “L” level control signals, the NMOS's 143-2 to 143-6 operating as a switch are turned off. Since the gradation voltage increases, an electric current through the NMOS 133 increases, and thus an electric current through the PMOS 131 increases. A mirror electric current through the PMOS 132 also increases, thus the differential amplification stage 130 outputs an increasing differential output voltage to the gate terminal of the PMOS's 141. In response to increasing differential output voltage, the gate of the PMOS 121 is slightly opened, and thus an electric current through the PMOS 121 decreases. Since the NMOS's 143-2 to 143-6 is in the off-state, the NMOS 142-2 to 142-6 does not operate in response to the bias voltage VBP. In this way, the increase of the gradation voltage is suppressed by the PMOS 121.

When a gradation voltage decreases in the second gradation voltage level, the hysteresis comparator 90A generates a “H” level comparative signal. In response to the “H” level comparative signal, the control signal generation circuit 90B generates “H” or “L” level control signals to the control terminals SI 2 to SI 6 of the PMOS buffer op-amp 82-4A. In response to the “L” or “H” level control signals, the NMOS's 143-2 to 143-6 operating as a switch are in off or on states. Since the gradation voltage decreases, an electric current through the NMOS 133 decreases, and thus an electric current through the PMOS 131 decreases. A mirror electric current through the PMOS 132 also decreases, thus the differential amplification stage 130 outputs an decreasing differential output voltage to the gate terminal of the PMOS 141. In response to decreasing differential output voltage, the gate of the PMOS 121 is largely opened, and thus an electric current through the PMOS 121 increases. Since the NMOS's 143-2 to 143-6 are in the on-state, On-state NMOS's among the NMOS 142-2 to 142-6 flow electric currents to the VSS terminal via the corresponding the NMOS's 143-2 to 143-6. In this way, the gradation voltage is generated by the PMOS 121 and controlled by the on-state NMOS's among the NMOS 142-2 to 142-6.

In the third gradation voltage level in which a gradation voltage on the output terminal OUT(V2) is higher than the high threshold voltage of V2+30 mV, the hysteresis comparator 90A generates a “H” level comparative signal to the control signal generation circuit 90B. In response to the “H” level comparative signal, the control signal generation circuit 90B generates “H” level control signals to the control terminals SI 2 to SI 6 of the PMOS buffer op-amp 82-4A. In response to the “H” level control signals, the NMOS's 143-2 to 143-6 are turned on. In response to the bias voltage VBP, the NMOS's 142-1 to 142-6 are also turned on so as to suppress the increase of the gradation voltage on the output terminal OUT(V2). Since the gradation voltage increases, an electric current through the NMOS 133 increases, and thus an electric current through the PMOS 131 increases. A mirror electric current through the PMOS 132 also increases, thus the differential amplification stage 130 outputs an increasing differential output voltage to the gate terminal of the PMOS's 141. In response to increasing differential output voltage, the gate of the PMOS 121 is slightly opened, and thus an electric current through the PMOS 121 decreases.

As shown in FIG. 11, the gradation voltage on the output terminal OUT(V2) decreases from the third gradation voltage level to the low threshold voltage VTL(=V2+10 mV), the hysteresis comparator 90A generates a “L” level comparative signal to the control signal generation circuit 90B. In response to the “L” level comparative signal, the control signal generation circuit 90B generates a “H” control signal to the control terminal SI 2 of the PMOS buffer op-amp 82-4A and “L” control signals to the control terminals SI 3 to SI 6. In response to the “H” and “L” level control signals, the NMOS 143-2 holds the on-state and the NMOS's 143-3 to 143-6 are turned off. In this way, the increase of the output voltage on the output terminal OUT(V2) is suppressed by only the NMOS 142-1 and NMOS 142-2, both of which are turned on.

As shown in FIG. 11, if the gradation voltage on the output terminal OUT(V2) increases again to the high threshold voltage VTH(=V2+20 mV), The hysteresis comparator 90A generates a “H” level comparative signal to the control signal generation circuit 90B. In response to the “L” level comparative signal, the control signal generation circuit 90B generates “H” control signal to the control terminal SI 2 to 5 of the PMOS buffer op-amp 82-4A and a “L” control signal to the control terminals SI 6. In response to the “H” and “L” level control signals, the NMOS 143-2 holds the on-state, the NMOS's 143-3 to 143-5 are again turned on, and the NMOS 143-6 holds the off-state. In this way, the increase of the output voltage on the output terminal OUT(V2) is suppressed by the NMOS 142-1 and NMOS 142-2 to 143-5, which are on-states.

As shown in FIG. 11, the gradation voltage on the output terminal OUT(V2) of the PMOS buffer op-amp 82-4A is repeatedly feedback-controlled so that the gradation voltage converges to a voltage in the range from the high threshold voltage VTH(=V2+30 mV) to the low threshold voltage VTL(=V2+10 mV).

According to the second embodiment, the hysteresis comparator 90A generates a “H” level comparative signal at the high threshold voltage VTH when a gradation voltage increases, and in addition, generates the “H” level comparative signal until the gradation voltage decreases to the low threshold voltage VTL. In response to the “H” level comparative signal, the control signal generation circuit 90B generates “H” or “L” control signals for selectively turning on/off the NMOS's 142-1 to 142-6. Therefore, the second embodiment can suppress excess increase and decrease of the gradation voltage on the output terminal OUT(V2) due to, for example, leakage electric currents from the external load connected to the output terminal OUT(V2) at high temperature, whereby to stabilize the gradation voltage.

The present invention is not limited to the first and second embodiments and the embodiments are modified as follows.

(a) In the first and second embodiments, only the op-amps 82-4 and 82-4A, each having the PMOS buffer, has the fine-controlling circuit according to the present invention. Other PMOS and NMOS buffer op-amps may have the fine-controlling circuit.

(b) In the second embodiment, the five NMOS's 142-2-142-6, each operating as a constant electric current source, are controlled so as to control the gradation voltage on the output terminal OUT(V2). The number of the NMOS's 142-2 to 142-6 is not limited to that of the second embodiment. In addition, the values of constant electric currents through the NMOS's 142-2 to 142-6 are individually and suitably configured.

(c) The circuit structures of the electric power circuit 80, the op-amps 82-1, the op-amps 82-1 to 82-5 and 82-4A, the hysteresis comparators 90A, 90B, and the control signal generation circuit 90B may be modified to other circuit structure excluding the drawings. The electric power circuit for driving a display panel according to the present invention can be utilized for other apparatus excluding the driver IC of the STN liquid crystal display panel.

(d) Values of the low and high threshold voltages are not limited to those of the hysteresis comparators 90, 90A of the first and second embodiments.

This application is based on Japanese Patent Application No. 2006-197719 which is herein incorporated by reference.

What is claimed is:

1. An electric power circuit for driving a display panel comprising:
a generation circuit for generating a plurality of reference voltages on corresponding reference voltage terminals thereof; and
a plurality of amplifiers for respectively amplifying said plurality of reference voltages so as to generate gradation voltages to gradation output terminals thereof,
wherein at least one of said amplifiers comprises:
a differential amplification circuit having a positive input terminal connected to said reference voltage terminal;
a buffer amp driven by an output of said differential amplification circuit, for generating said gradation voltage;
a feedback path by which said gradation voltage is fed back to a negative input terminal of said differential amplification circuit; and
a fine-controlling circuit for fine-controlling said gradation voltage.

2. An electric power circuit for driving a display panel according to the claim 1,
wherein
said buffer amp is a first output transistor having a first conductivity type, a conductivity of said first output transistor being controlled by said output of said differential amplification circuit, and
said fine-controlling circuit comprises:
a second output transistor having a second conductivity type, for providing a bypass electric current, a conductivity of said output transistor being controlled by said output of said differential amplification circuit,
a switching element having on/off-states for relaying said bypass electric current to said gradation voltage output terminal in said on-state; and
a comparative part for turning on said switching element when a difference between said gradation voltage and said reference voltage is equal to or larger than a predetermined voltage.

3. An electric power circuit for driving a display panel according to the claim 1,
wherein said fine-controlling circuit comprises:
a plurality of constant current source for respectively providing substantially constant bypass electric currents;
a plurality of switching elements, each having on/off-states, for respectively relaying said bypass electric currents to said gradation voltage output terminal in said on-states;
a comparative part for receiving said gradation voltage and said referential voltage so as to selectively turn on said switching elements in response to a difference between said gradation voltage and said reference voltage.

4. An electric power circuit for driving a display panel according to the claim 2,
wherein said comparative part includes a hysteresis comparator having a negative input terminal connected to said referential voltage terminal via a first resistor, and a positive input terminal connected to said gradation voltage output terminal via a second resistor.

5. An electric power circuit for driving a display panel according to the claim 3,
wherein said comparative part includes a hysteresis comparator having a negative input terminal connected to said referential voltage terminal via a first resistor, and a positive input terminal connected to said gradation voltage output terminal via a second resistor.
